(19) United States
(12) Patent Application Publication
(10) Pub. No.: US 2018/0004477 A1
(43) Pub. Date: Jan. 4, 2018

(54) INTEGRATED DISPLAY DEVICE FOR MOBILE TERMINAL

(71) Applicants: Seungwoo JANG, Icheon-si (KR); Duckha SHIN, Gumi-si (KR)

(72) Inventors: Seungwoo JANG, Icheon-si (KR); Duckha SHIN, Gumi-si (KR)

(21) Appl. No.: 15/478,756

(22) Filed: Apr. 4, 2017

(30) Foreign Application Priority Data
Jun. 29, 2016 (KR) 10-2016-0081321

(51) Int. Cl. G06F 3/14; G06F 3/0488; G06F 3/0481; G06T 3/40; G06F 1/16

(52) U.S. Cl. CPC G06F 3/1454; G06T 3/40; G06F 3/1423; G06F 1/1632; G06F 3/0481; G06F 3/0488

(57) ABSTRACT

Disclosed herein is an integrated display device for a mobile terminal. The integrated display device includes: a terminal connection module including an accommodation part configured to accommodate a mobile terminal, and a docking part connected to the mobile terminal via a multimedia transmission and reception terminal and configured to receive image data output from the mobile terminal; and a display module including a display part configured to include a display device larger than a display device of the mobile terminal, and a controller configured to include a resizing module adapted to resize the image data received from the docking part and provide the resized image data to the display part; wherein the display module is integrated with one side surface of the terminal connection module; and wherein at least one operation button is located on the front surface of the accommodation part.

### BACKGROUND

### 1. Technical Field

The present invention relates generally to an integrated display device for a mobile terminal, and more particularly to an integrated display device for a mobile terminal, which is coupled to a mobile terminal and enables a screen to be displayed on a larger display device, and which enables multimedia information and the like to be viewed for a long period of time in an outdoor environment in which it is difficult to supply power.

### 2. Description of the Related Art

Although there is a tendency for the screens of mobile terminals (mobile phones, PDAs, smartphones, etc.) to increase in size, mobile terminals cause the fatigue of eyes because they are smaller than those of tablet PCs which are equal to or larger than seven inches. However, it is difficult to rationalize purchasing tablet PCs for only the aforementioned reason because the functions of mobile terminals overlap those of tablet PCs.

Furthermore, in the case of a wireless communication data service plan supporting both a mobile terminal and a tablet PC, when separate subscriptions are made for the mobile terminal and the tablet PC, double fees must be paid. Even when a subscription is made to a recent service plan in which data can be shared based on a main line, a limitation may occur in that the tablet PC uses a larger amount of data than the mobile terminal due to its characteristics, and thus a restriction is soon imposed on the use of data, with the result that the wireless Internet can no longer be accessed.

Furthermore, the tablet PC market has not been developed compared to the mobile terminal market, and thus high-level security means, such as fingerprint recognition, iris recognition, etc., are chiefly concentrated on mobile terminals, with the result that tablet PCs have a problem with security. Additionally, from the point of view of software, when two devices are used, double accounts need to be maintained, and thus data needs to be located at two locations, thereby causing inconvenience when the data is managed or moved. Furthermore, common mobile terminals have a problem in that periods of use are short due to the limitation of batteries.

In order to overcome the above problem, an auxiliary display device for a mobile terminal has been proposed.

Korean Patent No. 10-1542455 entitled “Mobile Smartphone Docking System” discloses a mobile smartphone docking system in which a smartphone is mounted on the docking system, independent multiple display operations are performed on the smartphone and an external monitor, and multimedia information or the like can be viewed for a long period of time in an outdoor environment in which it is possible to use an external output but it is difficult to supply power.

In other words, a docking station configured such that a smartphone is rested thereon via a groove formed to a predetermined width in the upper portion of the upper surface thereof is formed, and the mobile smartphone docking system includes a smartphone docking system configured to receive image and audio data output from the smartphone and to output the image and audio data to an external monitor and a battery pack device configured to supply power to the smartphone docking system and the external monitor. The smartphone docking system includes: an external memory unit including a USB port configured to connect to a printer and other external devices (a multi-hub, an external hard disk/external memory, etc.), a TF port configured such that an MSD card is mounted thereon, and an SD port configured such that an SD card is mounted thereon; an operation display unit configured to display the operating status of the smartphone docking system; a smartphone connection unit configured to connect to a smartphone via an MUSB or USB; a mouse connection unit configured to connect to a mouse via a USB; a keyboard connection unit configured to connect to a keyboard via a USB; an audio input/output unit; a VGA port unit for VGA image data; an HDMI/DVI port unit configured to connect to an external monitor via an HDMI port or DVI port; external first and second power input units configured to supply required power to the smartphone connection unit, the HDMI/DVI port, the keyboard connection unit, the mouse connection unit, and the audio input/output unit; and a pairing button 195 configured to provide recognition to perform cooperative operation with the smartphone of a user. In this case, the battery pack device includes: a battery display unit configured to display the amount of remaining charge of a battery; a power display unit configured to display power operation status; external third and fourth power input units configured to charge a battery pack with power or to supply power; a docking system power supply unit configured to supply power to the smartphone docking system via the first USB port; a monitor power supply unit configured to supply power to a monitor via the second USB port; an external power supply unit configured to supply power to an external device via the third, fourth and fifth USB ports; and a touch signal input port configured to receive a touch signal from the monitor. In this case, the smartphone docking system and the battery pack device are detachably coupled to each other in a sliding manner, and the supply of power by the battery pack is blocked when the external first power unit or second power unit supplies power to the smartphone docking system.

However, the mobile smartphone docking system is configured such that separate output devices are separately provided and data is transmitted to the corresponding output devices via the mobile smartphone, and thus a problem arises in that portability is significantly lower because the separate output devices are main devices and the docking system functions only as a type of auxiliary device.

Furthermore, Korean Patent No. 10-1484045 entitled “Multi-display Device for Smartphone” discloses a multi-display device for a smartphone, which allows the smartphone to be mounted on a docking station, thereby enabling independent multi-display operations on both the smartphone and an external monitor and also enabling input to be received from the external monitor. The multi-display device for a smartphone includes: a smartphone including a short range communication unit and a plurality of frame buffer drivers; a docking station configured to enable the smartphone to be docked thereon and output a plurality of pieces of image data input from the smartphone; and an external monitor configured to receive and display image data output from the docking station and provide data on a touch location input from a user to the smartphone via the short range communication unit. In this case, the docking station includes: MHL terminals each configured to perform the input and output of the image data; and an image conversion unit configured to convert MHL image data, input from the smartphone, into HDMI or VGA image data.

However, the multi-display device is configured such that the docking station is formed to be separate from the display device, and thus a problem arises in that the multi-display device is not suitable for portable usage.

Therefore, there is an urgent need for an integrated display device for a mobile terminal, which is capable of overcoming the above-described critical problem, thereby enabling information displayed on a mobile terminal to be simultaneously output onto a portable large-sized display device operating in conjunction with the mobile terminal and also enabling a user to easily carry the integrated display device for a mobile terminal via a configuration having improved portability.

### SUMMARY

The present invention has been conceived to overcome the problems of the technology, and an object of the present invention is to provide a display device that receives image data stored in a mobile terminal and being displayed and displays the image data on a separate large-sized screen.

Another object of the present invention is to provide a display device that enables a mobile terminal to be easily controlled even in a state in which the mobile terminal has been connected to the integrated display device.

Still another object of the present invention is to provide a display device that ensures the portability of the integrated display device and provides a means for providing support without damaging the aesthetics of the appearance thereof.

Still another object of the present invention is to provide a display device that includes a separate sound output device, thereby supplementing the insufficient voice output of a conventional mobile terminal.

According to an aspect of the present invention, there is provided an integrated display device for a mobile terminal, the integrated display device including: a terminal connection module including an accommodation part configured to accommodate a mobile terminal, and a docking part connected to the mobile terminal via a multimedia transmission and reception terminal and configured to receive image data output from the mobile terminal; and a display module including a display part configured to include a display device larger than a display device of the mobile terminal, and a controller configured to include a resizing module adapted to resize the image data received from the docking part and provide the resized image data to the display part; wherein the display module is integrated with one side surface of the terminal connection module; wherein at least one operation button is located on the front surface of the accommodation part; and wherein the operation button further includes a pushing bar which extends from a location facing a physical switch to the operation button inside the accommodation part in order to operate the physical switch located on a side surface of the mobile terminal and which is bent at a specific angle to change a direction of force.

The display module may further include a cover part configured to surround the outside of the display part; and the back surfaces of the accommodation part and the cover part comprise a guide groove formed to traverse the back surfaces of the accommodation part and the cover part in a lengthwise direction, and a fastening shaft configured to be fitted into the guide groove and fasten the accommodation part and the cover part in a side-by-side state.

The terminal connection module may further include an external input part configured to receive image data from an external terminal via a separate multimedia transmission and reception terminal.

The display part may be comprised of a touch-type display; and the controller further includes: an application provision module configured to display a control window, configured to control provision of the image data to the display part, on the display part; and an operation control module configured to perform control that is displayed on the control window via a touch signal input to the display part by a user.

The fastening shaft may be formed in a column shape; the guide groove may be formed to be rounded to correspond to the fastening shaft, and the fastening shaft may be rotatably fitted into the guide groove; and a support rod formed to extend in a vertical direction may be formed on one side of a side surface of the fastening shaft.

The length of the fastening shaft may be formed to correspond to the length of the cover part; and the state in which the accommodation part and the cover part are fastened side by side is changed by laterally moving the fastening shaft in the state of being fitted into the guide groove.

A fastening depression depressed in a direction toward the inside of a back surface may be formed in a boundary portion between a back surface and one side surface of the accommodation part; and a fastening protrusion configured to protrude along the circumference of a surface at a location corresponding to the fastening depression may be formed at one end of the fastening shaft.

A plurality of through holes formed to penetrate into the front surface of the accommodation part may be formed through the fastening depression; the docking part may include an audio input part configured to receive audio data from the mobile terminal, and an audio transmission terminal configured to extend from the audio input part up to one side of a surface of the guide groove and be exposed out of the surface of the guide groove; an audio reception terminal configured to come into contact with the audio transmission terminal and receive the audio data may be formed on one side of a surface of the fastening shaft; and the fastening protrusion may include a speaker configured to convert the audio data into voice and output the audio.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing the basic form of an integrated display device for a mobile terminal according to the present invention;

FIG. 2 is a rear perspective view of the integrated display device for a mobile terminal;

FIG. 3 is a perspective view showing an embodiment in which a support means is mounted on the back surface of an integrated display device; and

FIG. 4 is a perspective view showing an embodiment in which a speaker is attached to a fastening shaft.

### DETAILED DESCRIPTION

Preferred embodiments of the present invention will be described with reference to the accompanying drawings. The accompanying drawings are not drawn to scale, and the same reference symbols designate the same components throughout the drawings.

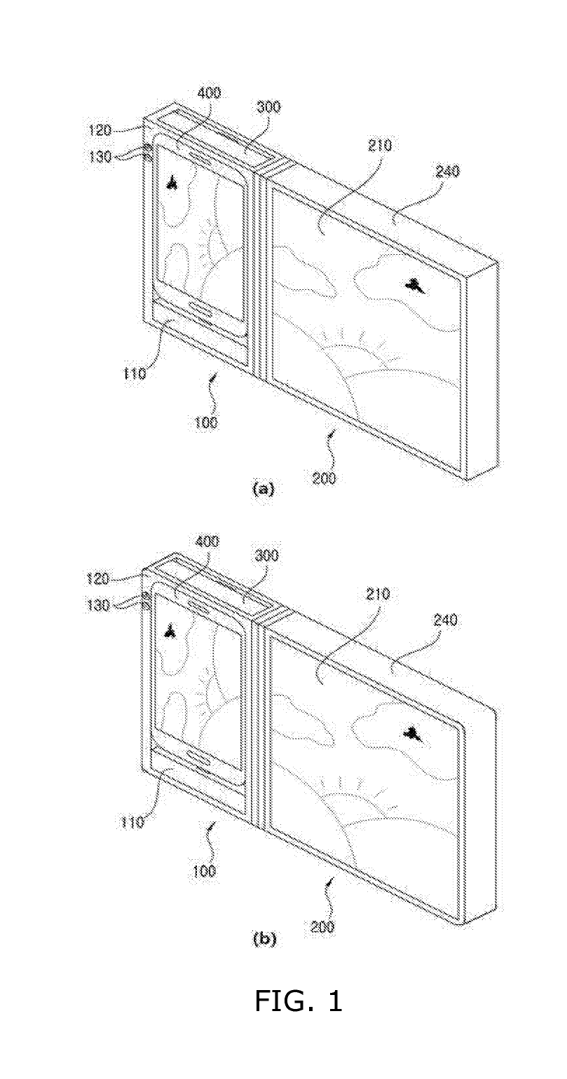

FIG. 1 is a perspective view showing the basic form of an integrated display device for a mobile terminal according to the present invention.

Referring to FIGS. 1(a) and 1(b), the integrated display device includes: a terminal connection module 100 including an accommodation part 120 configured to accommodate a mobile terminal 400, and a docking part 110 connected to the mobile terminal 400 via a multimedia transmission and reception terminal and configured to receive image data output from the mobile terminal 400; and a display module 200 including a display part 210 configured to include a display device larger than the display device of the mobile terminal 400, and a controller 230 configured to include a resizing module 231 adapted to resize the image data received from the docking part 110 and provide the resized image data to the display part 210. The display module 200 is integrated with one side surface of the terminal connection module 100.

Prior to the following description of the configuration of the present invention, the directions used herein are described first. Based on FIG. 1, the direction in which the display part 210 is located is called a front surface direction, and the direction in which a battery 220 is mounted is called a back surface direction. Based on the display module 200, the direction in which the terminal connection module 100 is located and the direction which is opposite to the direction in which the terminal connection module 100 is located are called side surface directions. The direction in which contact is made with a ground surface is called a bottom surface direction. Furthermore, the direction which is opposite to the bottom direction and in which the cover 300 of the terminal connection module 100 is located is called a top surface direction.

First, the terminal connection module 100 is a component configured to connect the mobile terminal 400 to the integrated display device and receive at least one of image data and audio data. Accordingly, the terminal connection module 100 includes the accommodation part 120 configured to accommodate the mobile terminal 400, and the docking part 110 connected to the mobile terminal 400 via the multimedia transmission and reception terminal and configured to receive image data output from the mobile terminal 400.

The mobile terminal 400 refers to a device that has a multimedia storage space and can play back multimedia, such as a mobile phone, a smartphone, a PDA, or the like. The mobile terminal 400 includes the multimedia transmission and reception terminal so that the mobile terminal 400 can transmit and receive image data and audio data to and from an external device. The multimedia transmission and reception terminal may employ, for example, a video graphics array (VGA) port using a VGA terminal, a digital video/visual interactive (DVI) port using a DVI terminal, a high definition multimedia interface (HDMI) port using an HDMI terminal, a mobile high definition link (MHL) port using a universal serial bus (USB) terminal, or the like. In particular, a method using the MHL port, which is a smartphone connection method that is most widely used recently, is most preferable, and the docking part 110 needs to be configured to correspond to the method.

The accommodation part 120 is a part in which the mobile terminal 400 is placed and stored. The accommodation part 120 needs to have a portable appearance and protect the mobile terminal 400, and thus is preferably made of material that has light weight and ensures durability, such as synthetic resin, silicone, TPU, or the like. The accommodation part 120 needs to be attached onto one side surface of a cover part 240 (which will be described later) including the display device, and thus the appearance of the accommodation part 120 needs to be preferably formed in a hexahedral shape, such as that shown in FIG. 1(a), or in a shape having rounded corners, such as that shown in FIG. 1(b). Furthermore, a storage space having the same shape as the mobile terminal 400 is formed inside the accommodation part 120 so that the mobile terminal 400 can be easily stored in the accommodation part 120. Alternatively, it will be apparent that a sufficient storage space may be formed, and a separate filling member may be used to fill a remaining space or a variable fastening means, such as an elastic shaft or the like, may be employed.

Furthermore, at least the portion of the accommodation part 120 which is a front surface and to which the display device of the mobile terminal 400 is oriented needs to be made of transparent material so that the mobile terminal 400 can be controlled by inputting a touch signal via the display device of the mobile terminal 400 after the mobile terminal 400 has been accommodated in the accommodation part 120. Furthermore, the front surface of the accommodation part 120 is preferably formed in a thin film or plate shape so that a touch signal can be input after the mobile terminal 400 has been accommodated in the accommodation part 120. Moreover, the accommodation part 120 may further include an openable cover 300 which can open the top surface thereof so that the mobile terminal 400 is introduced through the top surface and which can close the open top surface as desired.

Next, the display module 200 possesses a display device larger than a display device that is possessed by the mobile terminal 400. The display module 200 receives input image data via the mobile terminal 400 connected to the terminal connection module 100, and displays the input image data on the display device that is possessed by the display module 200. The display module 200 includes the display part 210 including the display device, and the controller 230 including the resizing module 231 configured to resize the image data received by the docking part 110 and provide the resized image data to the display part 210.

The display device refers to a display that can be used in a portable image device, such as an LCD, an LED, an IPS, an AMOLED, or the like. The display device attached onto the display module 200 needs to have a larger size than the display device that is possessed by the mobile terminal 400. Accordingly, the display device attached onto the display module 200 preferably has a seven or more inch size that is applied to a tablet PC, a netbook, etc.

Next, the controller 230 configured to provide the image data, received from the docking part 110, to the display part 210 is included. In particular, the controller 230 basically includes the resizing module 231 configured to resize the image data before providing the image data to the display part 210 in order to control the difference in resolution between the display device possessed by the mobile terminal 400 and the display device located in the display part 210 as a basic function. It will be apparent that the controller 230 may additionally perform various functions that are generally used to perform output to a display, such as a function of compensating for the difference in color, a function of rotating the output direction of image data, etc.

Furthermore, a battery 220 (not shown in FIG. 1) configured to supply power to the display part 210 may be included. In this case, a 3000 mAh or higher plate-shaped Li-ion or Li-polymer battery 220 may be generally used as the battery 220. Accordingly, the battery 220 is generally located on the back surface of the display part 210 where power can be smoothly supplied to the display part 210 and storage can be made easy. The battery 220 may supply power not only to the display part 210 but also to other required components. In other words, it will be apparent that the docking part 110 may receive power from the battery 220 and charge the connected mobile terminal 400 and that the battery 220 may supply power to an external input unit 500 to be described later.

The above-described configuration is the general configuration of the display module 200. According to the present invention, an integrated configuration may be obtained in such a way that the display module 200 is directly coupled to one side surface of the terminal connection module 100, or an integrated configuration may be obtained in such a way that the cover part 240 configured to surround the display part 210 is further included and is attached onto one side surface of the terminal connection module 100. In this case, the display module 200 and the terminal connection module 100 are coupled via a hinge that can be rotated in forward and backward directions, in which case the display module 200 and the terminal connection module 100 can be rotated in forward and backward directions via the hinge. The coupling between the display module 200 and the terminal connection module 100 may be implemented using at least one of rotatable couplers, such as bellows, a rotating shaft, etc. These coupling methods enable the display module 200 and the terminal connection module 100 to be rotated in forward and backward directions, and thus a user may locate the terminal connection module 100 connected to the mobile terminal 400 on one side surface, behind the display module 200 or the like as desired in various manners. Furthermore, in order to fasten the coupling, it will be apparent that well-known various locking methods, such as a method in which locking means including a slot and a protrusion are formed in the coupling portion, may be used.

Via the above-describe basic configuration, the mobile terminal 400 is coupled to the terminal connection module 100, image data stored in the mobile terminal 400 or being played back is received, and the received image data is displayed via the display part 210 located in the display module 200, thereby providing a display device that enables an image to be viewed on a large-sized screen without requiring a separate high-end central processing device, unlike a conventional tablet PC.

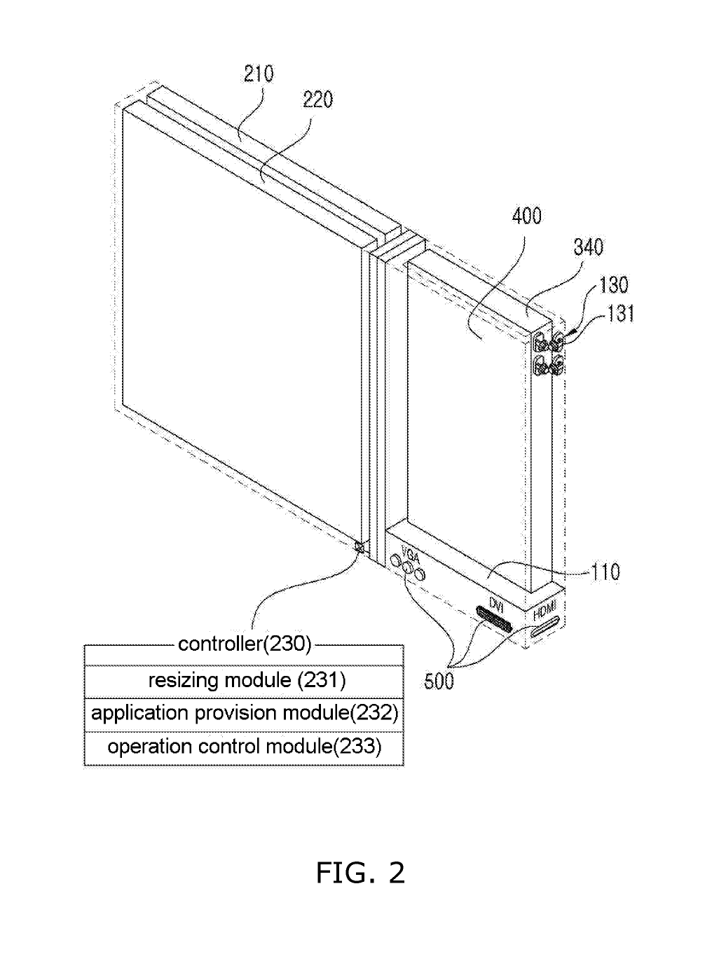

FIG. 2 is a rear perspective view showing the integrated display device for a mobile terminal.

Referring to FIG. 2, terminal connection module 100 may be configured to further include an external input part 500 configured to receive image information from an external terminal via separate multimedia transmission and reception terminals. These multimedia transmission and reception terminal may include a VGA port, an HDMI port, a DVI port, a USB port, and/or the like, as described above. The external input part 500 enables image data to be received from an external terminal (a computer, a TV, a smart TV, a monitor, a set-top box, or the like) via the separate multimedia transmission and reception terminal without the intervention of the docking part 110 located in the terminal connection module 100. Accordingly, a method of connecting another external terminal and performing display on the display part 210, other than the above method of connecting and using the mobile terminal 400 via the external input part 500, may be performed. Furthermore, it will be apparent that the external input part 500 may be formed at another location (for example, one side of the accommodation part 120, one side of the cover part 240, or the like) of the integrated display device via a separate extension line or the like.

Next, the display part 210 may be comprised of a touch-type display. The controller 230 may be configured to further include an application provision module 232 configured to display a control window, adapted to control the provision of image data to the display part 210, on the display part 210, and an operation control module 233 configured to perform control that is displayed on the control window via a touch signal input to the display part 210 by the user.

In other words, the display part 210 is comprised of a touch-type display, thereby enabling a user to directly input a command to the integrated display device via touch input. The controller 230 is configured to further includes the application provision module 232 configured to display the control window on the display part 210 in order to allow such a command to be more easily input and the operation control module 233 configured to perform control that is displayed on the control window via a touch signal input to the display part 210 by the user. The application provision module 232 functions to display the control window, configured to be displayed on the touch-type display and be controlled via touch input, on the display part 210. The operation control module 233 determines the location at which a touch signal has been received, and the direction and distance in and over which the touch signal has been moved by analyzing the corresponding touch signal received from the user while monitoring the touch-type display, and then performs corresponding control.

Next, one or more operation buttons 130 are located on the front surface of the accommodation part 120. Each of the operation buttons 130 is configured to include a pushing bar 131, extending from a location facing a physical switch from the inside of the accommodation part 120 to the operation button 130, in order to operate the physical switch located on one side surface of the mobile terminal 400. Generally, various physical switches (function keys), such as a power button, a volume control button, etc., are provided on the side surface of the mobile terminal 400. However, when the mobile terminal 400 is coupled to the docking part 110 and placed inside the accommodation part 120, it becomes difficult for a user to push the function keys. In order to overcome this phenomenon, the pushing bar 131 extending from the portion where the physical function key is located to the front surface of the accommodation part 120 through the accommodation part 120 is provided. The one or more operation buttons 130 are located on the front surface of the accommodation part 120 in order to enable such pushing bars 131 to be easily controlled.

Accordingly, when a user presses or pushes an operation button 130, a corresponding pushing bar 131 is pressed or pushed in conjunction with the operation button 130, and thus directly pushes a corresponding physical switch. Therefore, the pushing bar 131 is configured to use a bevel gear, capable of changing a direction of force, as an intermediate coupling portion or the pushing bar 131 itself is configured to change a direction of force by being bent at a specific angle, and thus the physical switch can be controlled by operating the operation button 130 located on the front surface of the accommodation part 120 without requiring a user to forcibly insert his or her finger or the like into a gap of the accommodation part 120 and then push the operation button 130. Furthermore, it will be apparent that the operation buttons 130 may be formed at another location (for example, one side of the accommodation part 120, one side of the cover part 240, or the like) of the integrated display device via separate extensions or the like.

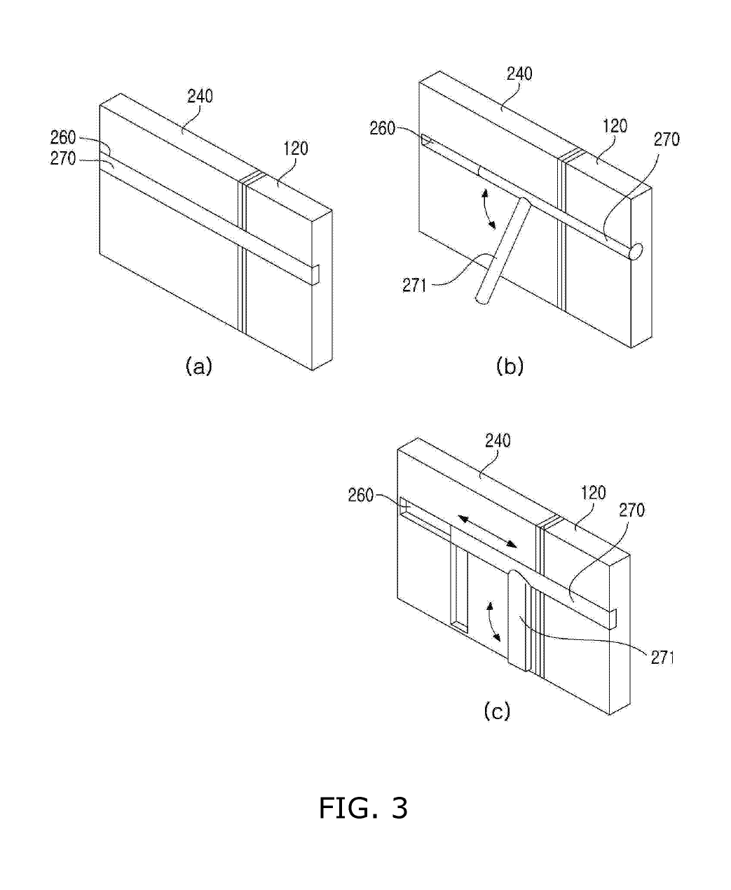

FIG. 3 is a perspective view showing an embodiment in which a support means is mounted on the back surface of an integrated display device.

As described above, the integrated display device for a mobile terminal 400 includes two modules, i.e., a terminal connection module 100 and a display module 200, these two modules are coupled to each other, and the coupling may be implemented through simple coupling or may be implemented via a hinge, a rotating shaft, bellows, or the like. It will be apparent that a display part 210 is the main component of the present device and thus the location of the terminal connection module 100 where the mobile terminal 400 is located does not constitute a great problem after the mobile terminal 400 has been controlled such that image data can be provided to the display part 210. However, in some cases, while image data is being displayed on the display part 210, there occur cases where there is a need to operate or control the mobile terminal 400. A representative example is a case where it is desired to enjoy web surfing simply by using a large-sized screen during the web surfing. In this case, it is preferred that the terminal connection module 100 and the display module 200 are always coupled in a side-by-side state. Accordingly, there is a need for a fastening means for maintaining a state in which the terminal connection module 100 and the display module 200 have been coupled side by side.

A configuration for implementing such a fastening means includes: a guide groove 260 formed across the back surfaces of an accommodation part 120 and a cover part 240 in a lengthwise direction; and a fastening shaft 270 configured to be fitted into the guide groove 260 and then fasten the accommodation part 120 and the cover part 240 in a side-by-side state.

First, the guide groove 260 is formed to traverse the back surfaces of the accommodation part 120 and the cover part 240 in a lengthwise direction when they are arranged side by side. Although the height at which the guide groove 260 is formed is not particularly limited to a specific height, the guide groove 260 is preferably formed at a location at least a predetermined distance away from the bottom surface in order to form a support rod 271 to be described later. The fastening shaft 270 is fitted into the guide groove 260 in order to fasten the accommodation part 120 and the cover part 240 in a side-by-side state. In other words, like a latch used to lock a conventional hinged door, the fastening shaft 270 is fitted into the guide groove 260, thereby fastening the accommodation part 120 and the cover part 240 in a side-by-side state.

The fastening shaft 270 may be modified, as follows. A first modification is configured such that the fastening shaft 270 is rotatably inserted into the guide groove 260 and a support rod 271 configured to extend from one side of the side surface of the fastening shaft 270 in a direction perpendicular to the fastening shaft 270 is additionally provided.

First, the fastening shaft 270 is rotatably fitted into the guide groove 260. For this purpose, the fastening shaft 270 needs to be formed in a column shape, and the guide groove 260 needs to be also formed in a corresponding shape. Furthermore, the support rod 271 configured to extend from one side of the side surface of the fastening shaft 270 in a direction perpendicular to the fastening shaft 270 is additionally provided. This support rod 271 functions as a support for supporting the back surfaces of the accommodation part 120 and the cover part 240, as in a book holder, an easel, or the like. The fastening shaft 270 may be fitted into and rotated in the guide groove 260. In this case, the support rod 271 is added to the fastening shaft 270. In other words, the rotation range of the support rod 271 can be controlled by making both side walls of the guide groove 260 different, thereby using the support rod 271 as a support.

Furthermore, for a case where the support rod 271 is not used in the state where the fastening shaft 270 and the guide groove 260 have been coupled to each other, the support rod 271 may be prevented from obstructing the use of the device in such a way that a depression is formed in a shape corresponding to that of the support rod 271 at the location of the support rod 271 on the back surfaces of the accommodation part 120 and the cover part 240 and then the support rod 271 is inserted into the depression by rotating the fastening shaft 270 as desired.

A second modification may be configured such that the length of the fastening shaft 270 is formed to correspond to the length of the cover part 240 and the fastening shaft 270 is laterally moved in the state of being fitted into the guide groove 260, thereby changing the state where the accommodation part 120 and the cover part 240 have been fastened side by side.

When the maximum length of the fastening shaft 270 is formed to correspond to the length of the cover part 240, the state where the accommodation part 120 and the cover part 240 have been fastened side by side may be controlled by laterally moving the fastening shaft 270 in the state of being fitted into the guide groove 260 even when the fastening shaft 270 is not removed from the guide groove 260. Referring to the drawing, when the fastening shaft 270 is maximally pushed to the left along the guide groove 260, the fastening shaft 270 does not interfere with the movement of the accommodation part 120, and thus the accommodation part 120 can be freely rotated, as in the case where there is no fastening shaft 270. In contrast, when the fastening shaft 270 is maximally pushed to the right, the fastening shaft 270 interferes with the movement of the accommodation part 120, and thus the state in which the accommodation part 120 and the cover part 240 are fastened side by side can be maintained.

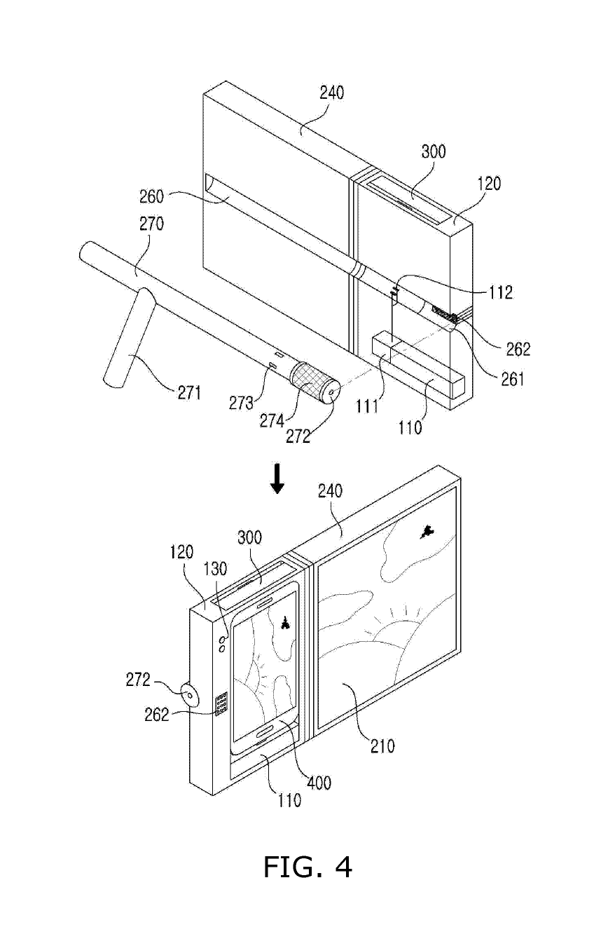

FIG. 4 is a perspective view showing an embodiment in which a speaker is attached to a fastening shaft.

FIG. 4 shows another embodiment of a fastening shaft 270 and a guide groove 260, in which the fastening shaft 270 is configured to perform not only the function of a fastening/support means but also a rotation fastening function and the function of a speaker 274. In the previous configuration, although audio data is output via the mobile terminal, it is difficult to distinguish various channels by using only the output of the speaker 274 of the mobile terminal, and a problem in which sound is distorted when the volume of sound is significantly large or significantly small audio data is output because the speaker 274 is constructed only for a call purpose may occur. In order to overcome these problems, a fastening protrusion 272 configured to enable the fastening shaft 270 to be used as the speaker 274 is provided.

First, the configuration of the fastening protrusion 272 is described. A fastening depression 261 formed into a predetermined depth in a direction internally extending from the back surface of an accommodation part 120 is provided in a boundary portion between the back surface and one side surface of the accommodation part 120, and the fastening protrusion 272 protruding around a surface at a location corresponding to the fastening depression 261 is provided at one end of the fastening shaft 270.

In other words, the fastening depression 261 formed to a predetermined length and the predetermined depth is provided in the boundary portion between the back surface and one side surface of the accommodation part 120 and at one end of the guide groove 260 in the guide groove 260. Furthermore, the fastening protrusion 272 protruding around the surface of the one end of the fastening shaft 270 at the location corresponding to the fastening depression 261 is provided at one end of the fastening shaft 270. In other words, although the sizes and shapes of the fastening depression 261 and the fastening protrusion 272 are not particularly limited, the fastening depression 261 and the fastening protrusion 272 are preferably formed in a shape similar to a cylindrical shape so that fastening shaft 270 can be rotated inside the guide groove 260 and the fastening protrusion 272 is sufficiently fastened in the state of being fitted into the fastening depression 261.

Next, a plurality of through holes 262 configured to penetrate into the front surface of the accommodation part 120 is formed through the fastening depression 261, an audio input part 111 configured to receive audio data from the mobile terminal 400 and an audio transmission terminal 112 extending from the audio input part 111 to one side of the surface of the guide groove 260 and exposed out of the surface of the guide groove 260 is provided on the docking part 110, an audio reception terminal 273 configured to come into contact with the audio transmission terminal 112 and receive audio data is provided on one side surface of the fastening shaft 270, and a speaker 274 configured to convert audio data into audio and output the audio is provided on the fastening protrusion 272.

First, a plurality of through holes 262 configured to penetrating from the back surface of the accommodation part 120 to the front surface thereof is formed through the fastening depression 261. These through holes 262 form paths through which the audio output from the speaker 274 provided in the fastening protrusion 272 is desirably transferred.

Next, the docking part 110 further includes the audio input part 111 configured to receive audio data stored in the mobile terminal 400 or being currently played back, and the audio transmission terminal 112 configured to extend from the audio input part 111 to one side of the surface of the guide groove 260 and be exposed out of the surface of the guide groove 260. In other words, the audio input part 111 receives the audio data, and transmits the received audio data up to one side of the surface of the guide groove 260 via the audio transmission terminal 112. Accordingly, the audio transmission terminal 112 performs a function similar to that of a type of communication line capable of transmitting data.

The audio reception terminal 273 configured to come into contact with the audio transmission terminal 112 and receive audio data is provided on one side surface of the fastening shaft 270, and the speaker 274 configured to convert audio data into voice and output the audio is provided in the fastening protrusion 272 formed at the one end of the fastening shaft 270. In other words, when the audio transmission terminal 112 and the audio reception terminal 273 come into contact with each other, audio data can be transferred from the mobile terminal 400 to the fastening shaft 270. The speaker 274 configured to convert audio data into voice perceived by a human and output the audio is provided in the fastening protrusion 272 formed at the one end of the fastening shaft 270, and thus the audio data is finally output via the speaker 274 in the form of voice. Prior to the above operation, voice is efficiently transferred to the front surface of the accommodation part 120 via the through holes 262, and thus an audio transfer problem, which has been a problem of conventional art, can be overcome. Furthermore, the speaker 274 greater in output and size than that of the mobile terminal 400 is employed, and thus the application of realistic sound channels and the improvement of sound quality can be expected.

Via the above-described configuration, an image stored in the mobile terminal 400 or being displayed on the mobile terminal 400 can be viewed via a large-sized screen at less expensive costs than a tablet PC.

The integrated display device for a mobile terminal according to the present invention has the following advantages:

1. The display device including the docking part and the large-sized screen are provided so that data can be displayed on a larger screen through connection to the mobile terminal.

2. The separate physical key is mounted outside the terminal connection module in which the mobile terminal is located, and thus operation can be easily performed even when the mobile terminal is connected to the display device.

3. The guide groove is formed to traverse the back surface of the display device and the fastening shaft is fitted into the guide groove, and thus the display device can be maintained in the state of being spread.

4. The plurality of speakers is additionally mounted on the fastening shaft, and thus a sound effect can be improved.

While the integrated display device for a mobile terminal according to the present invention has been described and illustrated in the above description and the attached drawing, this is merely an example, the spirit of the present invention is not limited to the above description and the attached drawings, and various changes and modifications can be made without departing from the scope of the technical spirit of the present invention.

What is claimed is:

1. An integrated display device for a mobile terminal, the integrated display device comprising:
a terminal connection module including:
an accommodation part configured to accommodate a mobile terminal; and
a docking part connected to the mobile terminal via a multimedia transmission and reception terminal, and configured to receive image data output from the mobile terminal; and
a display module including:
a display part configured to include a display device larger than a display device of the mobile terminal; and
a controller configured to include a resizing module adapted to resize the image data received from the docking part and provide the resized image data to the display part;
wherein the display module is integrated with one side surface of the terminal connection module;
wherein at least one operation button is located on a front surface of the accommodation part; and
wherein the operation button further includes a pushing bar which extends from a location facing a physical switch to the operation button inside the accommodation part in order to operate the physical switch located on a side surface of the mobile terminal and which is bent at a specific angle to change a direction of force.

2. The integrated display device of claim 1, wherein:
the display module further includes a cover part configured to surround an outside of the display part; and
back surfaces of the accommodation part and the cover part comprise:
a guide groove formed to traverse the back surfaces of the accommodation part and the cover part in a lengthwise direction; and
a fastening shaft configured to be fitted into the guide groove and fasten the accommodation part and the cover part in a side-by-side state.

3. The integrated display device of claim 1, wherein the terminal connection module further includes an external input part configured to receive image data from an external terminal via a separate multimedia transmission and reception terminal.

4. The integrated display device of claim 1, wherein:
the display part is comprised of a touch-type display; and
the controller further includes:
an application provision module configured to display a control window, configured to control provision of the image data to the display part, on the display part; and
an operation control module configured to perform control that is displayed on the control window via a touch signal input to the display part by a user.

5. The integrated display device of claim 2, wherein:
the fastening shaft is formed in a column shape;
the guide groove is formed to be rounded to correspond to the fastening shaft, and the fastening shaft is rotatably fitted into the guide groove; and
a support rod formed to extend in a vertical direction is formed on one side of a side surface of the fastening shaft.

6. The integrated display device of claim 5, wherein:
a length of the fastening shaft is formed to correspond to a length of the cover part; and
the state in which the accommodation part and the cover part are fastened side by side is changed by laterally moving the fastening shaft in a state of being fitted into the guide groove.

7. The integrated display device of claim 5, wherein:
a fastening depression depressed in a direction toward an inside of a back surface is formed in a boundary portion between a back surface and one side surface of the accommodation part; and
a fastening protrusion configured to protrude along a circumference of a surface at a location corresponding to the fastening depression is formed at one end of the fastening shaft.

8. The integrated display device of claim 7, wherein:
a plurality of through holes formed to penetrate into the front surface of the accommodation part is formed through the fastening depression;
the docking part includes:
an audio input part configured to receive audio data from the mobile terminal; and
an audio transmission terminal configured to extend from the audio input part up to one side of a surface of the guide groove and be exposed out of the surface of the guide groove;
an audio reception terminal configured to come into contact with the audio transmission terminal and receive the audio data is formed on one side of a surface of the fastening shaft; and
the fastening protrusion includes a speaker configured to convert the audio data into voice and output the audio.
